(19) United States
(12) Patent Application Publication
(10) Pub. No.: US 2006/0028011 A1
(43) Pub. Date: Feb. 9, 2006

(54) System and method of advertising

(76) Inventor: John Young, Overland Park, KS (US)

Correspondence Address: HARNESS, DICKEY, & PIERCE, P.L.C, 7700 BONHOMME, STE 400, ST. LOUIS, MO, 63105, US

(21) Appl. No.: 11/059,208

(22) Filed: Feb. 16, 2005

Related U.S. Application Data
(60) Provisional application No. 60/599,108, filed on Aug. 5, 2004.

(51) Int. Cl. B42D 15/00

(52) U.S. Cl. 283/56

(57) ABSTRACT

A method of advertising by displaying an advertisement in a business directory. The advertisement includes at least one panel depicting a story and includes contact information for a provider offering a product or service. Also a method of producing a business directory including an advertisement associated with a service offered by a provider.

### CROSS-REFERENCE TO RELATED APPLICATIONS

This application claims the benefit of U.S. Provisional Application No. 60/599,108, filed on Aug. 5, 2004. The disclosure of the above application is incorporated herein by reference.

### FIELD OF THE INVENTION

The present invention relates to a method and system of advertising and more specifically, a method and system for displaying an advertisement in a business directory.

### BACKGROUND OF THE INVENTION

Businesses often utilize a business directory for advertising the services they offer and/or the products they sell. Business directories can be a telecommunication company “Yellow Pages,” a webpage, a community directory, a professional services publication, and an association membership publication. These media often group service providers by the type of product or service that they sell or provide.

However, generally these advertisements do not draw attention to one particular service provider except as to name or description of products or services offered. Often, potential customers select a particular service provider to contact based on previous awareness, service provider name, description of the good or service or advertising a character or well known person or image of a person or character.

Generally, current advertisements in business directories lack attention getting appeal to the public and only provide moderate success in attracting potential customer awareness and associated customer contacts. As such, there is a need in the industry for a system and method of advertising that attracts potential customer attention, identifies one or more problems to be solved, provides an awareness of the services or products offered, and solicits customer contact by providing service provider contact information coincidental with the attention attracting features.

### SUMMARY OF THE INVENTION

The inventor hereof has designed a method and system for improving the effectiveness of advertisement in a business directory.

In one aspect of the invention, a method of advertising includes displaying an advertisement in a business directory. At least one panel depicts a story and includes contact information for a provider offering a product or service.

In another aspect of the invention, a method of producing a business directory includes an advertisement associated with a service or product offered by a provider. The method includes generating the advertisement having at least one panel depicting a story associated with the offered service or product. Contact information for the provider is provided in the panel. The advertisement is displayed in the business directory.

Further aspects of the present invention will be in part apparent and in part pointed out below. It should be understood that various aspects of the invention may be implemented individually or in combination with one another. It should also be understood that the detailed description and drawings, while indicating certain exemplary embodiments of the invention, are intended for purposes of illustration only and should not be construed as limiting the scope of the invention.

### BRIEF DESCRIPTION OF THE DRAWINGS

The present invention will become more fully understood from the detailed description and the accompanying drawings.

FIG. 1 is single panel advertisement depicting a story and including provider contact information according to one embodiment of the invention.

FIG. 2 is an image representation of a cover of a business directory for displaying an advertisement according to another embodiment of the invention.

FIG. 3 is an image representation of a single page within a business directory according to another embodiment of the invention.

FIG. 4 is a multi-panel advertisement depicting a story and including provider contact information according to another embodiment of the invention.

FIG. 5 is a flow chart of a method of advertising according to another embodiment of the invention.

FIG. 6 is a flow chart of a method of producing a business directory according to another embodiment of the invention.

Like reference symbols indicate like elements or features throughout the drawings.

### DETAILED DESCRIPTION

The following description is merely exemplary in nature and is in no way intended to limit the invention, its applications, or uses.

In one embodiment of the invention, a method of advertising includes displaying an advertisement in a business directory. The advertisement includes at least one panel depicting a story and includes contact information for a provider offering a product or service. This method can be better understood by referring to the figures.

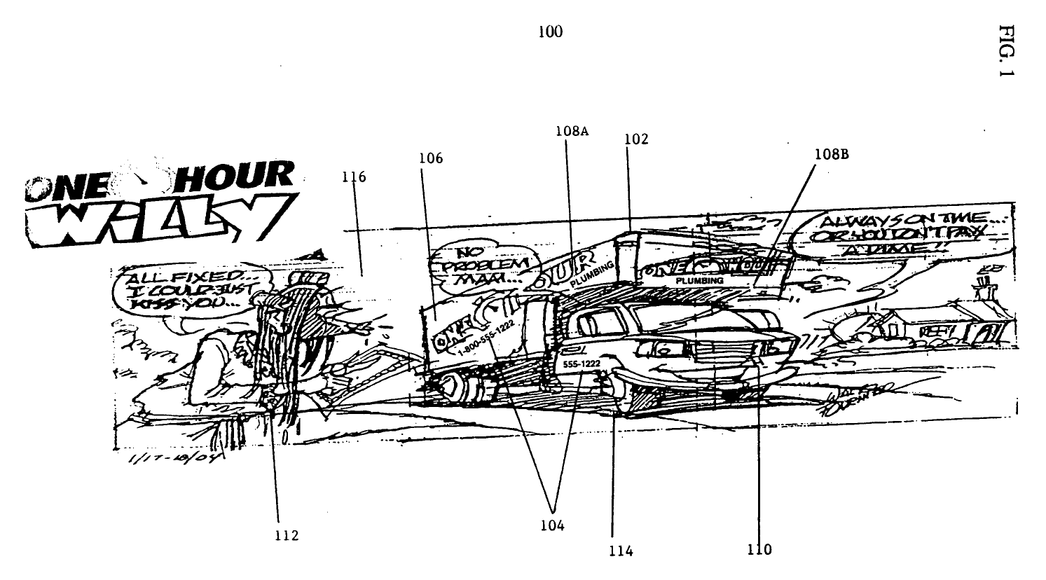

As illustrated in FIG. 1, a single panel advertisement 100 includes a single panel 102 and a depicted story 116. The depicted story 116 in this example is a service or product provider 114 as represented by a truck 110 that has just offered a service or delivered a good to a customer 112. The customer 112 shows appreciation for the successful receipt of the service or product by the provider. The depicted story 116 includes displaying on the truck 110 a name of the provider 108A and 108B, illustrated as “One Hour Plumbing,” and a contact information 104, illustrated as 1-800-555-1212.

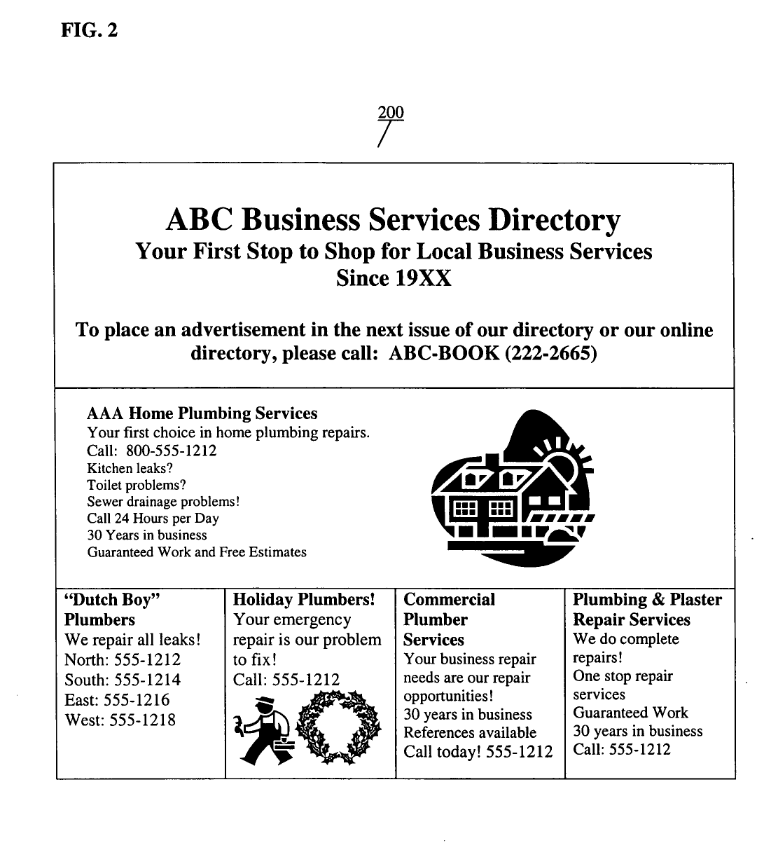

The single panel advertisement 100 is displayed in a business directory 200 as illustrated by example in FIG. 2. The business directory 200 (e.g., an advertising directory of businesses) can be any type of business directory that a potential customer can refer to when considering a purchase of a product or service as offered by the provider 114. The business directory 200 can be in a hard copy format or soft copy format and can include a telecommunication carrier business directory, a catalogue, a membership directory, a journal, a newspaper, a trade magazine, a trade periodical, and/or a webpage.

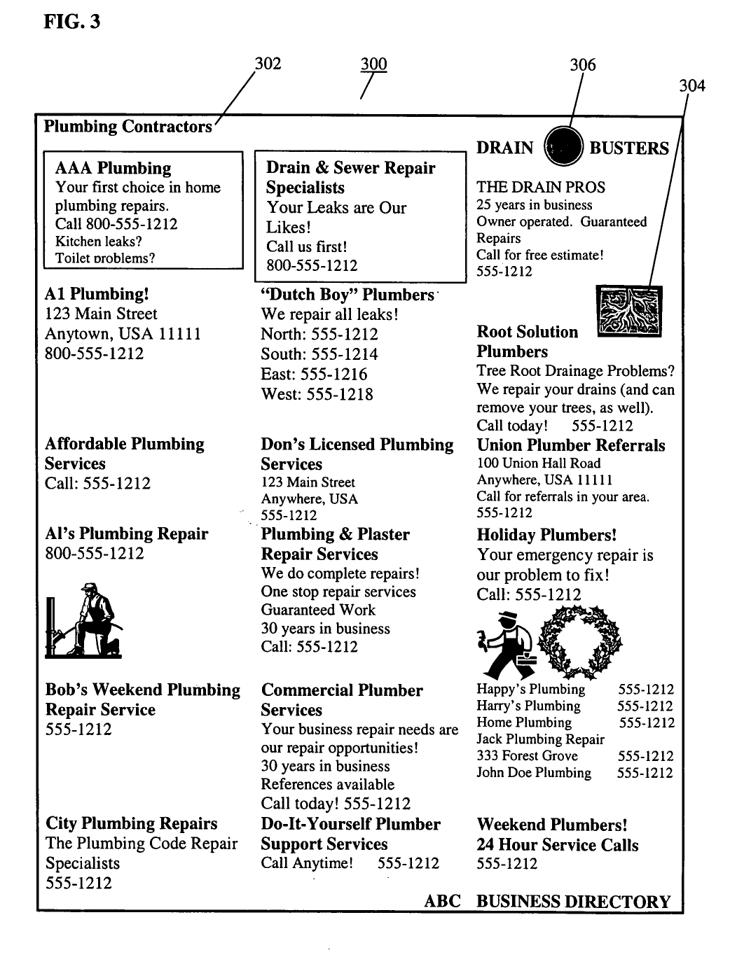

The business directory 200 includes one or more pages as illustrated, by way of example, in FIG. 3. The business directory page 300 typically is organized by a service or product offered by various groups or categories of providers. As illustrated in the business directory page 300, a service provider category 302 for this page indicates a plumbing service category. In this example, typical advertisements 304 and 306 identify a provider by a name, contact number, a listing of services offered, a business logo, service mark, trademark, and/or one or more characters. Such advertisements do not depict a story, such as the depicted story 116. According to various embodiments of the invention, the advertisement 100 or 400 can be displayed in proximity to the listing of other providers providing similar or competing services or products and/or in proximity to a listing for the same provider identified in the advertisement 100 or 400. As such, the advertisement 100 or 400 operates to attract the attention of a potential customer accessing the business directory 200 and the business directory page 300 and provide an endorsement of the provider. The advertisement 100 or 400 can be the entire business directory page 300 or a portion of business directory page 300.

The depicted story 116 can include a drawing, text, and/or dialogue. One or more of these features can be displayed in association with displaying the depicted story 116 in the panel 102. For example, the depicted story 116 can include text balloons, a bulb above a character's head, or other known forms of story illustration. The depicted story 116 can generally include an account or recital of an event or a series of events that can either be true or fictitious. The depicted story 116 can include an endorsement element such as an account or report regarding the facts of an event or group of events related to a need for and quality of the provider's offered services or products. In one preferred embodiment, the depicted story 116 is a fictional prose or verse narrative intended to interest or amuse the potential customer while at the same time providing an endorsement and identification of the provider.

In some embodiments, the contact information 104 can include a telephone number, a web site address, an email address, a text messaging address, a mailing address, and a physical address.

As illustrated in FIG. 1, the method of advertising includes displaying the depicted story 116 on the single panel 102. However, in other embodiments, a plurality of panels 102 102A-N can depict the story 116. When a plurality of panels 102 depicts the story 116, the depicted story 116 can be a connected story that is connected between two or more panels 102. The depicted story 116 can also include a fictional story relating to one of the provider's 114 products or services and can include one or more endorsement elements or features. In one preferred embodiment, the depicted story 116 can be a cartoon. Such a cartoon can be a drawing or set of drawings depicting a humorous situation and can be accompanied by a caption or dialogue.

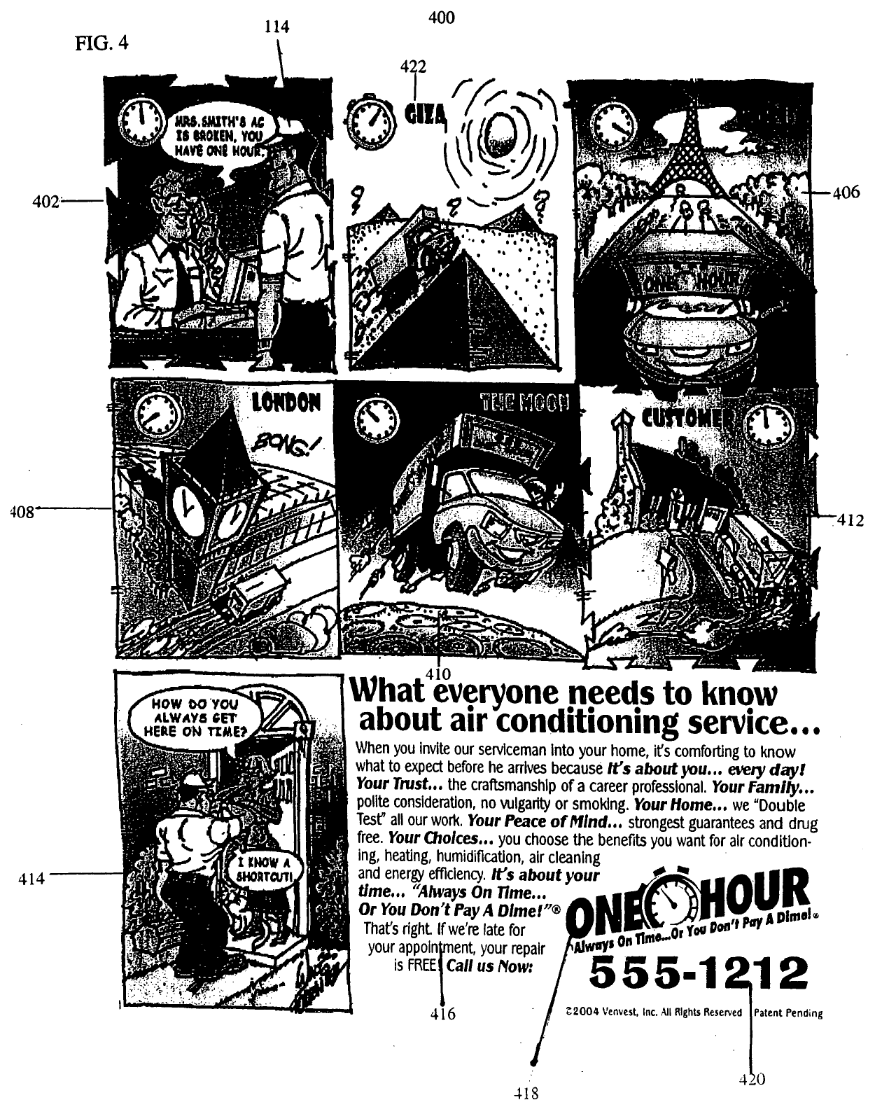

When the embodiment includes the plurality of panels 102, in one embodiment, a final panel 102N can include the provider contact information 104. An example, of a multi-panel advertisement according to one embodiment is illustrated in FIG. 4.

In FIG. 4, a multi-panel advertisement 400 includes a plurality of panels 402-416. As illustrated, a final panel 416 includes both an identification of the service provider 418 and a contact information 420 for the identified service provider 418. Additionally, as depicted in panels 402 to 414, a connected story is provided among all frames 402 to 414 thereby holding a customer's attention when the multi-panel advertisement 400 is displayed. In some embodiments, each of panels 402-414 can contain an image or display that have a substantial consistent appearance from one panel to the next. For example, as illustrated in panels 402-414 the provider 114 utilizes the truck 422 throughout panels 404 to 412 to travel by outrageous means to deliver a service to a customer.

In another embodiment, a method of producing business directory 200 includes the advertisement 100 associated with a product or service offered by the provider 114. The advertisement 100 is generated for and placed into the business directory 200. The advertisement 100 includes at least one panel with the depicted story 116 associated with a service or product offered by the provider 114. The panel includes the contact information 104 for the provider 114 and can include the name 108 of the provider 114. The method also includes displaying advertisement 100 in business directory 200.

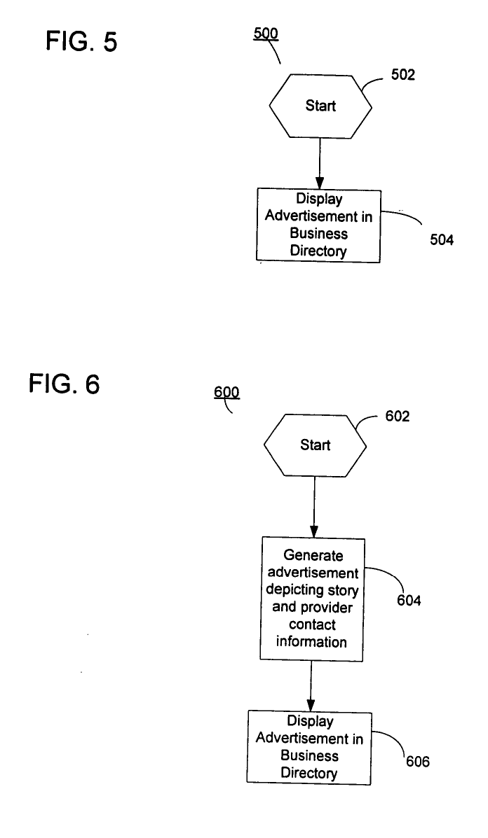

Referring now to FIG. 5, a flow chart 500 illustrates a method of advertising according to one exemplary embodiment of the invention. The method starts in process 502. In process 504, an advertisement is displayed in a business directory. The advertisement includes one or more panels depicting a story and includes contact information for a provider offering a product or service.

FIG. 6 is a flow chart of a method of producing a business directory according to some embodiments of the invention. This method starts at a process 602. In a process 604, an advertisement associated with a service offered by a provider is generated to include one or more panels depicting a story associated with the offered service. The panels include contact information for the service provider. In a process 606, the advertisement is displayed in the business directory.

One or more embodiments of the invention described herein provide improved customer recognition of a provider's business and/or offered products or services. Additionally, various embodiments may also provide improved marketing and/or increased sales of the provider's products or services.

When describing elements or features of the present invention or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the invention. Accordingly, all matter contained in the above description or shown in the accompanying drawings should be interpreted as illustrative and not in a limiting sense.

It is further to be understood that the steps described herein are not to be construed as necessarily requiring their performance in the particular order discussed or illustrated. It is also to be understood that additional or alternative steps may be employed.

What is claimed is:

1. A method of advertising comprising displaying an advertisement in a business directory, the advertisement including at least one panel depicting a story, said at least one panel including contact information for a provider offering a product or service.

2. The method of claim 1 wherein the advertisement includes a plurality of panels.

3. The method of claim 2 wherein said story is a connective story and the plurality of panels depict the connective story.

4. The method of claim 2 wherein the plurality of panels include a final panel, the final panel including the contact information.

5. The method of claim 2 wherein each of the plurality of panels contains a substantially consistent appearance.

6. The method of claim 1 wherein the depicted story includes a drawing.

7. The method of claim 1 wherein the depicted story includes text.

8. The method of claim 7 wherein the text includes a dialogue.

9. The method of claim 1 wherein the depicted story includes an endorsement element.

10. The method of claim 1 wherein the contact information is selected from the group consisting of a telephone number, a web site address, an email address, a text messaging address, a mailing address, and a physical address.

11. The method of claim 1 wherein the business directory is at least one of a hard copy format or a soft copy format.

12. The method of claim 1 wherein the business directory is one of a yellow pages, a catalogue, and a journal.

13. The method of claim 1 wherein the depicted story is a fictional story relating to one of said product and service offered by said provider.

14. The method of claim 1 wherein the depicted story is a cartoon relating to one of said product and service offered by said provider.

15. The method of claim 1 further comprising distributing the business directory to a user.

16. The method of claim 1 wherein displaying the advertisement includes displaying in proximity to a list of service providers for an associated service.

17. A method of producing a business directory including an advertisement associated with a service offered by a provider, the method comprising:
generating the advertisement including at least one panel depicting a story associated with the offered service, said at least one panel including contact information for the service provider; and
displaying the advertisement in the business directory.

18. The method of claim 17 wherein the advertisement includes a plurality of panels.

19. The method of claim 18 wherein the plurality of panels depicts a connective story.

20. The method of claim 18 wherein a final panel of the plurality of panels including the contact information.

21. The method of claim 18 wherein the depicted story in each of the plurality of panels includes a substantially consistent appearance.

22. The method of claim 17 wherein the depicted story include an endorsement element.

23. The method of claim 17 wherein the depicted story includes a drawing.

24. The method of claim 17 wherein the depicted story includes text.

25. The method of claim 24 wherein the text includes a dialogue.

26. The method of claim 17 wherein the contact information is selected from the group consisting of a telephone number, a web site address, an email address, a text messaging address, a mailing address, and a physical address.

27. The method of claim 17 wherein the business directory is at least one of a hard copy format or a soft copy format.

28. The method of claim 17 wherein the depicted story is a fictional story.

29. The method of claim 17 wherein the depicted story is a cartoon.

30. The method of claim 17 wherein displaying the advertisement is displaying in proximity to a list of service providers for an associated service.
